(19) United States
(12) Patent Application Publication
(10) Pub. No.: US 2019/0025875 A1
(43) Pub. Date: Jan. 24, 2019

(54) VISUAL BLOCKING DEVICE FOR THE SCREEN OF SMART DEVICES

(71) Applicant: MGNT APPS & CRAFTS, LDA, Leiria (PT)

(72) Inventor: Ana Luisa SERRA RIBEIRO DA SILVA, Leiria (PT)

(73) Assignee: MGNT APPS & CRAFTS, LDA, Leiria (PT)

(21) Appl. No.: 15/748,746

(22) PCT Filed: Jul. 31, 2015
(86) PCT No.: PCT/PT2015/050003

§ 371 Date: Jan. 30, 2018

(51) Int. Cl. G06F 1/16; H04M 1/02; H04M 1/725

(52) U.S. Cl. CPC G06F 1/1603; G06F 1/1607; G06F 2200/1633; H04M 1/72544; H04M 1/0254

(57) ABSTRACT

Visual blocking device for the screen of smart devices, refers to a device to be coupled to an electronic smart device for blocking the visualization of part of the screen of said device. The visual blocking device comprises at least one barrier element to block the visualization of one or more portions of the screen of the electronic device when it is used by several users with an application executed on the electronic device that requires that the different portions of the screen cannot be seen by the different users or players using the smart device. It is especially useful for playing virtual board games or other table top games on the electronic device, preventing the different players to see the cards or game pieces of the opponent players at the same time that only each user can see its cards or game pieces.

### OBJECT OF THE INVENTION

The present invention, visual blocking device for the screen of smart devices, refers to a device to be coupled to an electronic smart device for blocking the visualization of part of the screen of said device. Said smart device can be any mobile device with a screen such as an electronic tablet, a smartphone, a phablet or a table computer (real size table that has a screen as table top). The visual blocking device comprises at least one barrier element to block the visualization of one or more portions of the screen of the electronic device when it is used by several users with an application executed on the electronic device that requires that the different portions of the screen cannot be seen by the different users or players using the smart device. It is especially useful for playing virtual board games or other table top games on the electronic device, preventing the different players to see the cards or game pieces of the opponent players at the same time that only each user can see its cards or game pieces.

The invention is referred to the field of accessories and elements for electronic smart devices, such as tablets and smartphones.

### PRIOR ART OF THE INVENTION

The development of new technologies has made that new applications for electronic smart devices appear such as virtual board games to be played online by different players that require each player to have a smart device that must be connected between them, usually through a private or public network, or even Bluetooth connections between devices.

Further, and up to date, no board games that require hiding information, cards or game pieces from one player to the others and played by different players can be played simultaneously on an only electronic smart device because it is not possible to prevent the different player to see the cards or game pieces of its opponents. For example, different players could play one domino game using its personal electronic smart devices connected to the same network, but it is not possible to play a domino game on only one electronic smart device by different players because the domino pieces of each player could be seen by its opponents unless the pieces are covered by the hand of each player, which is not at all comfortable.

It is true that in the state of the art are widely known different designs of accessories or supports for smart devices, but none of them allow blocking partially the screen of said devices.

Therefore, the present invention provides a visual blocking device of the screen of smart devices, that can have an individual configuration directly attached to the smart device or a group configuration that require a case of the smart device as attachment between the smart device and the visual blocking device.

### SUMMARY OF THE INVENTION

The first object of the invention is, as stated in claim 1, a device or accessory comprising at least one barrier element, coupled to the smart device in an individual or plural (more than one barrier element associated between them) way, that allows the division of the screen of the smart device in portions or areas in such a way that the different users or players of the application executed on the smart device can only see their corresponding portion or area of the screen plus a common area on the screen, and preventing its portion of the screen to be seen by the other users or players.

Specifically, claim 1 refers to a visual blocking device for the screen of a smart device comprising at least one barrier element with a surface inclined with respect to the screen to prevent the visualization of part of the screen of the smart device and first attaching means to couple the barrier element to the smart device.

Further, the barrier element of the visual blocking device comprises a surface with its area smaller that the area of the screen of the smart device, and further comprises conversion means that allow a portion of said surface of the barrier element to change from a first position parallel and in contact with the screen to a second position with a portion of the surface separated from the screen, so that when the portion of the surface of the barrier element is positioned separated from the screen it blocks the visualization of a portion of the screen from a rear position and allows the visualization of said portion of the screen from a front position.

This blocking device with a barrier element can be individually attached to the smart device through the first attaching means or it can be attached to said smart device through second attaching means placed between the barrier element and the first attaching means. In this second option the visual blocking device comprises at least one, preferably between two and four, barrier element being the first attaching means to the smart device a case where the barrier element or elements is coupled, stored or introduced through said second attaching means. The main body of said case will usually be similar to the known smart device cases of the type that comprise a rear frame and four small walls on its edgeways where the smart device is coupled, stored or introduced leaving the screen of the smart device accessible on the top side of the case. These cases usually comprise a cover to hide and protect the screen of the smart device.

The visual blocking device of the present invention comprises, in some of its embodiments, a case as attaching means to the smart device in addition to the barrier elements that make possible the visual blocking of some portions of the screen.

As stated, the visual blocking device comprises at least one barrier element, that can be of a flexible material, such as polyurethane (PU) or a deformable one, such as silicone, that when in use determines a wall that prevents the vision of the portion of the screen covered by said barrier by the users or players located behind or at the sides of the barrier, but allows the vision of said portion of the screen by the user in front of the barrier. Other plastic materials, for example rigid ones, could be ABS, PC (polycarbonate), PP (polypropylene) or even bi-materials obtained with injection techniques, being these flexible or rigid. Further flexible materials such as PU can be used with an inner rigid layer made of plastic, metal or card. The barrier element, depending on its material, might be rigid or bendable son that it can be completely flat, therefore parallel and in contact with the screen when they are not in use. Said barrier elements, when in use, may have a part of its surface in contact with the screen and another part separated from said screen, in such a way that the separated part can be parallel to the screen or be angled with respect to the screen.

The conversion means of the barrier elements, from the first position to the second position, in the visual blocking device can be slots made in the silicone material that allow obtaining the desired shape of the barrier element by twisting the silicone material or magnets incorporated in the material of the barrier element, of PU or card, that allow the shaping of said barrier element.

The number of barrier elements to be placed on the electronic smart device will be the same as the number of users or players using the application executed on the smart device, which will normally be between two and four, each of them placed on one side of the four sides of the screen, although only one barrier element could be used too.

When the visual blocking device comprises only one barrier element, the first coupling means to the smart device are part of said barrier element and preferably have a U-shape section for adjusting to the edgeways of the smart device, preferably by pressure exerted on both sides of the smart device due to the construction material of the blocking device.

As already mentioned, in an alternative embodiment, the barrier element or elements are coupled through second attaching means to the first attaching means, attaching means preferably being a case where the smart device is coupled or introduced. These second attaching means allow the barrier element or elements to be correctly coupled and placed on the screen. In the embodiments where the barrier elements are attached to the case through the second attaching means, it will be possible to use exclusively the number of barrier elements that are required, while the other barrier elements remain folded preferably on the rear side of the device or on top of the screen preferably within a blocking sheet. Said blocking sheet is a sheet that incorporates the barrier elements within and that can be attached too to the case in addition to the protective cover that the covers of the smart device usually include.

When the visual blocking device comprises a case as first attaching means, the barrier element or the blocking device are placed in said blocking sheet that comprises a window, wherein said window has an area smaller than the area of the screen and it is attached to said case through the second attaching means. Preferably, said window is centered with respect to the blocking sheet and centered with respect to the screen of the smart device.

In an alternative embodiment, the at least one barrier element, preferably at least two, is placed in an elastic band attached to the case, instead of being placed in the blocking sheet. Usually one barrier element will be included in an independent elastic band, up to a total of four bands. Said elastic bands, preferably of silicone, cross the case from one side to its opposite, being connected the elastic bands to the sides of the case through the second attaching means.

Said second attaching means can have different embodiments, such as, for example:
a foldable sheet connected to the case with a hinged connection between the blocking sheet and the foldable sheet, and between the foldable sheet and the case too,
a hinged connection between the case and the blocking sheet,
a projection on one the edgeways of the case that allows the blocking sheet to rotate with respect to said projection and therefore with respect to the case, or
slots in the top and/or rear part of the case for the insertion within said slots of the blocking sheet with the barrier elements.

In a further alternative embodiment, the at least two barrier elements are incorporated in a rear sheet that is attached to the rear side of the case through the second attaching means, which are snap fit connections. In this embodiment, the at least two barrier elements have a hinge connection to go from the rear side of the case to over the screen of the smart device. Further, it is possible to have barrier elements directly coupled to the case through snap fit connections too, having the rear part of the case of the smart device in this embodiment, housings to couple when not in use the barrier elements.

The barrier elements have a surface with an inclination with respect to the screen of the smart device that is between 30° and 90° depending on the material and constructional features of the barrier element. Said barrier elements can be with a constant or unchanging structure or a collapsible structure or a structure with different parts that can be folded to obtain the desired barrier effect.

### DESCRIPTION OF THE FIGURES

The previous and other advantages and features will be more deeply understood from the following detailed description of embodiments, with reference to the attached, which must be considered in an illustrative and non-limiting manner in which:

FIG. 1 shows a perspective view of one embodiment of a visual blocking device according to the invention, where an individual barrier coupled to the smart device is shown.

FIGS. 2 and 3 show perspective views of two additional embodiments of the invention, although in these embodiments the barrier elements are coupled to a case.

FIG. 4 shows a plan view of an embodiment of a rear sheet coupled to the rear part of the case where the spaces where the barrier elements are coupled when not in use.

FIG. 5 shows a perspective view from below of the example of FIG. 4 where the gap to include the barrier elements is shown.

FIG. 6 shows a detail of the coupling of the rear sheet to the case through snap fit couplings, although other coupling or fixing means can be used such as adhesives.

FIG. 7 shows an third embodiment with a projection on one the edgeways of the case that allows the blocking sheet, where the barriers are incorporated, to rotate with respect to said projection and therefore with respect to the case, being said blocking sheet a continuation of the cover of the case. The barriers are in a first position, pleated on the screen.

FIG. 8 shows a detail of the embodiment of FIG. 7 where the barrier is in the second position, that is to say folded out.

FIG. 9 shows the process for moving the cover of the case in the third embodiment from on top of the screen of the smart device to under the case, positioning on top of the screen the blocking sheet with the barriers.

FIG. 10 shows a detail of the projection in the case.

FIG. 11 shows a fourth embodiment where the case of the smart device includes four elastic bands with the barriers in a first position, therefore pleated.

FIG. 12 shows detail of the embodiment of FIG. 11 where a barrier is in the second position, that is to say folded out.

FIG. 13 shows the process for moving the elastic bands from the rear side of the cover to the front side on top of the screen of the smart device.

FIG. 14 shows a fifth embodiment where the cover of the case is a foldable sheet connected to the case with a hinged connection, further comprising a hinged connection between the blocking sheet, containing the barriers, and the foldable sheet. The barriers are in a folded out position.

FIG. 15 shows the process for moving the cover of the case in the fifth embodiment from the top of the screen of the smart device to under the case, positioning on top of the screen the blocking sheet with the barriers.

FIG. 16 shows three details of the process for pleating the barrier from a first position to the second position where it is maintained due to the action of magnets.

FIG. 17 shows a sixth embodiment where the cover of the case and the blocking sheet is the same as the one of the fifth embodiment with alternative barriers.

FIG. 18 shows a top view of a barrier in the first position, pleated.

FIG. 19 shows a detail of a barrier in the process of being folded out including magnets and a detail of the barrier in the second position, completely folded out due to the action of the magnets.

FIG. 20 shows a seventh embodiment where the blocking sheet is hinged to the case, between the screen and the cover, said blocking sheet having the shape in its second position of a stadium.

FIG. 21 shows the process for opening the cover of the case in the seventh embodiment from the top of the screen of the smart device to under the case, so that the blocking sheet includes a stadium, as a barrier, that is folded out due to its construction material, and when the cover of the case is placed on top of the blocking sheet with the stadium, the stadium returns to its first position, that is to say, pleated.

FIG. 22 shows an eighth embodiment where the case comprises slots in the top and rear part of the same and the barriers are included in the blocking sheet in a pleated position. In said slots the blocking sheet with the barrier elements and the cover are inserted.

FIG. 23 shows the process of the eighth embodiment for moving the blocking sheet with the barriers from the rear slots of the case to the front slots on top of the screen.

FIG. 24 shows a barrier in a second position, therefore folded out.

FIG. 25 shows a ninth embodiment showing two details of a blocking sheet with a barrier in a first position and in a second position.

FIG. 26 shows the process

FIG. 27 shows a section of the details of FIG. 25.

FIG. 28 shows a tenth embodiment where the blocking sheet including the barriers is pressed on the case of the smart device.

FIG. 29 shows the process of the tenth embodiment for placing the blocking sheet from the rear side of the case to the front side on top of the screen.

FIG. 30 shows a top view of an expanded barrier element to be used as blocking element on another embodiment.

FIG. 31 shows a side view of the folded out barrier element of FIG. 30.

FIG. 32 shows a side detail of first attaching means of the barrier element of FIGS. 30 and 31 to a smart device.

FIG. 33 shows a side detail of second attaching means of the barrier element of FIGS. 30 and 31 to a case of a smart device as first attaching means.

FIG. 34 shows a perspective view of the barrier element of FIGS. 30 and 31 with the second attaching means.

FIG. 35 shows a view of a case as first attaching means for a barrier element as the one in FIG. 34.

FIG. 36 shows a barrier element of FIG. 34 being coupled to the case of FIG. 35.

FIG. 37 shows an lower view of FIG. 36.

### PREFERRED EMBODIMENTS

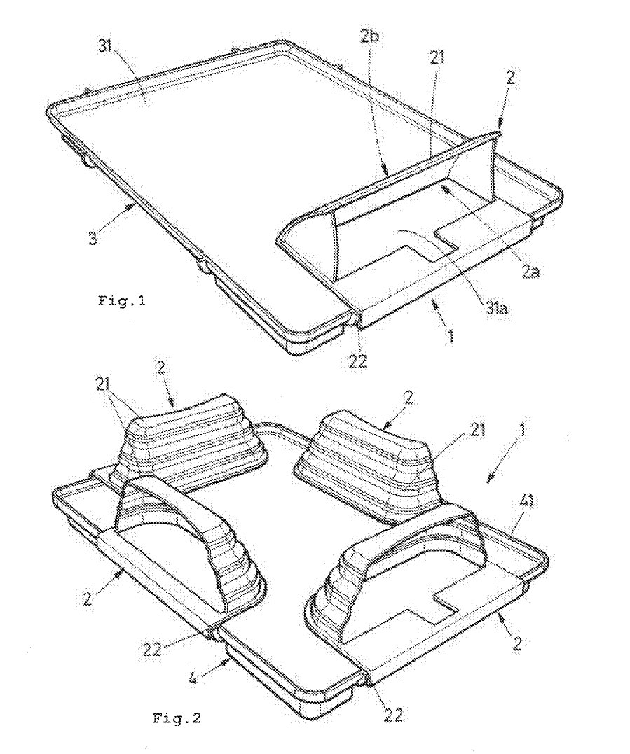

In view of the attached figures, FIG. 1 shows a visual blocking device of the screen 31 of smart devices 3 comprising first attaching means 22 to the smart device 3, and at least one barrier element 2, comprising said barrier element 2 a surface 21 with its area smaller that the area of the screen 31 of the smart device 3, and conversion means that allow a portion of said surface of the barrier element 2 to change from a first position parallel and in contact with the screen 31 to a second position with a portion of the surface separated from the screen 31, so when the portion of the surface of the barrier element 2 is positioned separated from the screen 31 it blocks the visualization of a portion 31a of the screen from a rear position and allows the visualization of said portion 31a of the screen from a front position 2a. Said barrier elements can therefore be collapsible.

Preferably, the element that makes up said barrier 2 has an opaque wall or surface 21 that is preferably foldable comprising first attaching means 22 for coupling the barrier element directly on the smart device. Said first attaching means have a U-shape section for adjusting to the edgeways of the smart device 3, preferably by pressure.

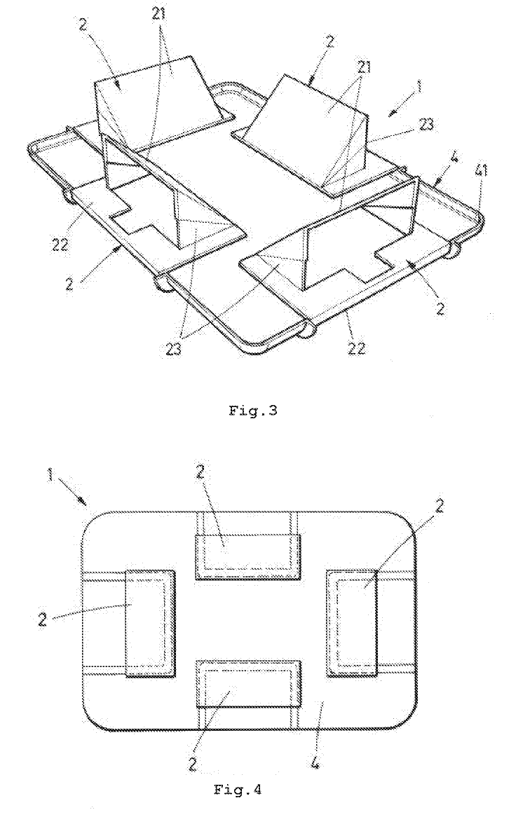

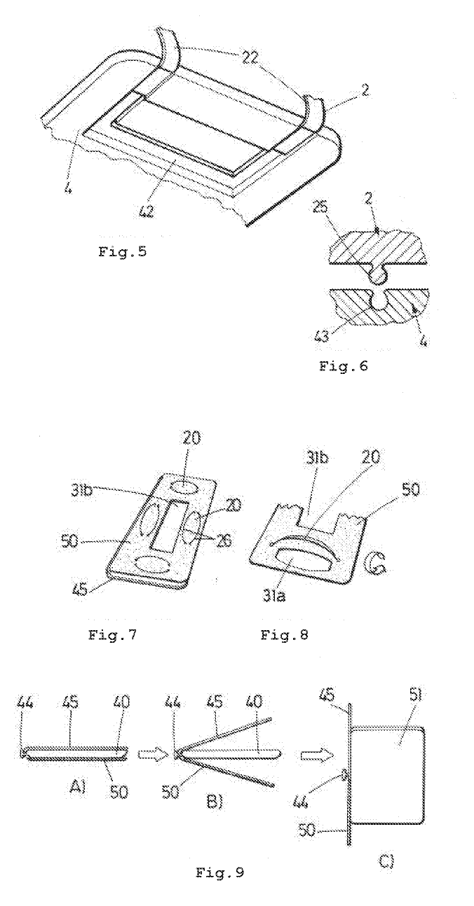

FIGS. 2 and 3 show an alternative where the barrier elements 2 of the visual blocking device are coupled to the smart device through first attaching means in the form of a case 4 that has flanges 41 in its perimeter to keep the smart device with the screen 31 within said flanges 41. In these embodiments, four barrier elements 2 are placed on the screen 31, each barrier element 2 blocking the view of a portion of the screen to the user or player that is not in front of each barrier element 2. A wider portion of the screen 31 is free in the middle of the screen 31 between the barrier elements 2 and is where the common information for the users in shown on the screen 31 of the smart device. In these embodiments, the barrier elements 2 are coupled to the first attaching means or case 4 through second attaching means 22 that are snap fits, and the barrier elements 2 couple by pressure to the case 4, as shown in FIG. 6.

The case 4 preferably has the shape and dimension required to have the smart device coupled within, and it further comprises housings in its rear part to allow the insertion of the barrier elements 2 when they are not in use.

The barrier elements 2 are preferably foldable, for example with sides 23 of the surface 21 folded to maintain the elevated position of the surface 21. The position of the sides 23 and the surface 21 of the barrier element 2 is maintained using conversion means in the form of magnets embedded in the material, which is preferably polyurethane (PU). Another alternative requires the use as conversion means of a silicone material with low profiles or folds 24 in the barrier element 2 that allow folding and stretching as an accordion.

In this way, the barrier elements 2 are coupled to the case 4 through the second attaching means, so that when they are not in use the barrier elements 2 can be turned and hide in the rear part of the case 4 in a flat position, specifically in housings 42 for this purpose. When the barrier elements 2 are introduced in its housings 42 the surfaces of the same are aligned with the surface of the rear part of the case 4 making its use comfortable.

In these embodiments, the surface of the barrier element, mainly surface 21 is inclined between 30° and 80° with respect to the screen 31 of the smart device 3.

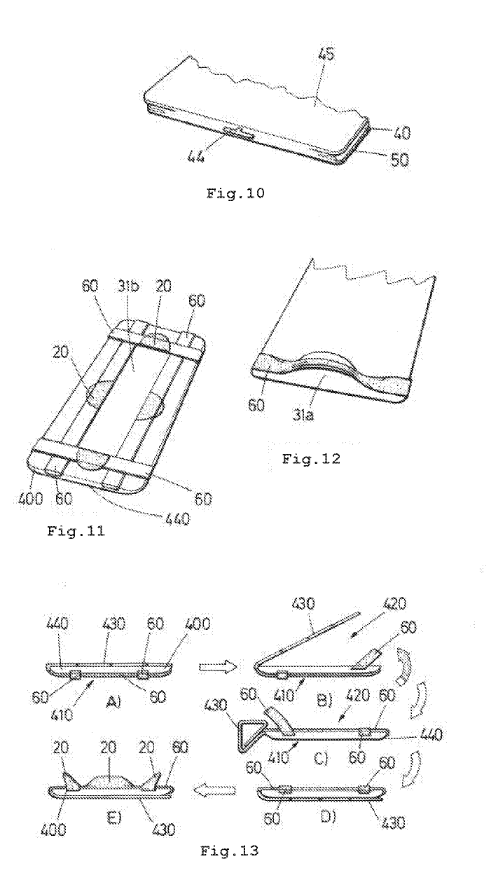

FIGS. 7 to 10 show an alternative embodiment of a visual blocking device object of the present application. In this embodiment, the first attaching means are a case 40, made of polycarbonate, where the smart device 3 is introduced for protection, said case 40 comprising a projection 44 on one edgeway or flange 41 where the cover sheet 45 of the case and a blocking sheet 50, that is continuation of the cover 45, rotate (see FIG. 9, steps A to C). The blocking sheet 50 acts as second attaching means where the barriers 20, with its surface, are included. The cover 45 and the blocking sheet 50 are made of PU and polycarbonate with silicone insertions respectively. The cover sheet 45 and the blocking sheet 50 although of different materials are only one component. The blocking sheet 50 comprises four barriers 20, although it could include less than four, on its surface and each of them is made by two confronted curved slots 26 that can be twisted (FIG. 8) due to the content of silicone in the blocking barrier 50 to change from a first position in contact with the screen 31 (FIG. 7) to a second position separated form said screen 31 (FIG. 8). In said first position the barriers 20 are pleated while in the second position the barriers are folded out in respect to the blocking sheet 50. The process for moving the blocking sheet 50 to the top of the screen 31 consists, as shown in FIG. 9, steps A to C, in opening the cover 45 and after rotating the group formed by the cover 42 and the blocking sheet 50 with respect to the projection 44, place the blocking sheet 50 with the barriers 20 on top of the screen 31 and the cover 45 underneath the case 40. Once on top of the screen 31 the barrier can be folded out. Once folded out the desired number of barriers 20, portions 31a of the screen 31 can be seen exclusively by the user placed in front of the barrier 20, preventing the users behind the barrier 20 from seeing the portion of the screen 31a in front of said barrier 20. The blocking sheet 50 comprises a window centered in the sheet 50 that allows another portion 31b of the screen 31 to be seen by all the users.

In these embodiments, the surface of the barrier element, mainly surface 20 is inclined between 30° and 60° with respect to the screen 31 of the smart device 3.

FIGS. 11 to 13, show another embodiment where the first attaching means are a case 400 with a foldable cover 430 and the second attaching means are four elastic bands 60, although only one, two or three 60 could be used too, coupled to the sides 440 of the case 400. The case 400 is preferably made of polycarbonate and the elastic bands 60 are preferably made of silicone. The barriers 20, with its surface, are preferably placed in the middle of each of said elastic bands 60, and each of them 60 is made by two confronted curved slots 26 that can be twisted due to the silicone in the elastic band 60 to change from a first position in contact with the screen 31 (FIG. 11) to a second position separated from said screen 31 (FIG. 12). The process (FIG. 13, steps A to E) for moving the elastic band 60 from the rear 410 side of the case 400 to the front side 420 on top of the screen 31, requires that the cover 430 is foldable and after folding the same and moving it away from the screen 31, the elastic bands 60 can be moved from the rear side 410 of the case to the front side 420 by extending the bands 60 and passing them along the lateral sides 440 of the case 400. After moving the bands 60 to the front side 420 of the case 400, the same 60 cover partially the screen 31 of the smart device, and when the barriers 20 are folded out, a portion of the screen 31a is determined that can only be seen by the user in front of said barrier 20. Further, when the elastic bands 60 are on the front side 420 of the case 400, cover some parts of the screen delimiting another portion of the screen 31b placed in the middle of the screen 31 of the device and that can be seen by all the users or players.

In these embodiments, the surface of the barrier element, mainly surface 20 is inclined between 30° and 60° with respect to the screen 31 of the smart device 3.

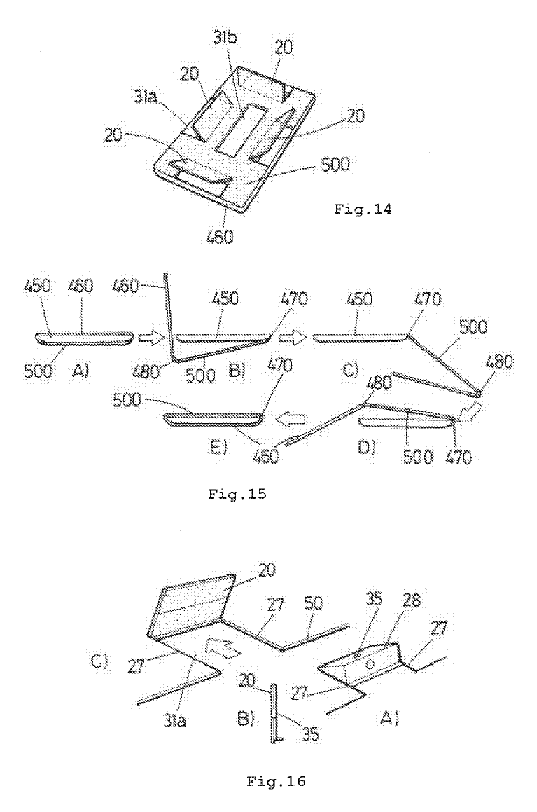

FIGS. 14 to 16 show another embodiment of the invention where the visual blocking device comprises a case 450 as first attaching means and a blocking sheet 500 as second attaching means, said second attaching means 500 comprising the barrier elements 20 with a surface. The case 450, made in polycarbonate, comprises a cover 460, made in polyurethane, coupled to said case 450 through the blocking sheet 500. The blocking sheet 500 is connected to the cover 460, as an extension of the same, and is made of polyurethane, polypropylene or polycarbonate among others. The cover 460 of the case 450 is a foldable sheet connected to the blocking sheet 500 with a first hinged connection 480, further comprising a second hinged connection 470 between the blocking sheet 500, containing the barriers 20, and the case 450. In FIG. 15, the steps A to E are shown for moving the cover 460 from the front side of the case 450, where the screen 31 of the smart device is, to the rear side of the case 450 at the same time that the blocking sheet 500 is moved on the contrary. Once the blocking sheet 500 is placed on top of the screen 31, the barrier elements 20 can be folded out to start using the smart device by the different users. In this case, the barrier elements 20 are made up of cuts 27 in the blocking sheet 500 that determine square or rectangular surfaces 20. Said surfaces 20 have a folding line 28 and due to the inclusion of magnets 35 in the polyurethane material of the barrier elements 20, the surfaces 20 when folded through the folding line 28 remain fixed due to the action of the magnets 35 constituting the barriers 20 in a folded out position (FIG. 16, steps A to C). Once folded out the desired number of barriers 20, portions 31a of the screen 31 can be seen exclusively by the user placed in front of the barrier 20, preventing the users behind the barrier 20 from seeing the portion of the screen 31a in front of said barrier 20. The blocking sheet 500 comprises a window centered in the sheet 500 that allows another portion 31b of the screen 31 to be seen by all the users.

In these embodiments, the surface of the barrier element, mainly surface 20 is inclined between 30° and 70° with respect to the screen 31 of the smart device 3.

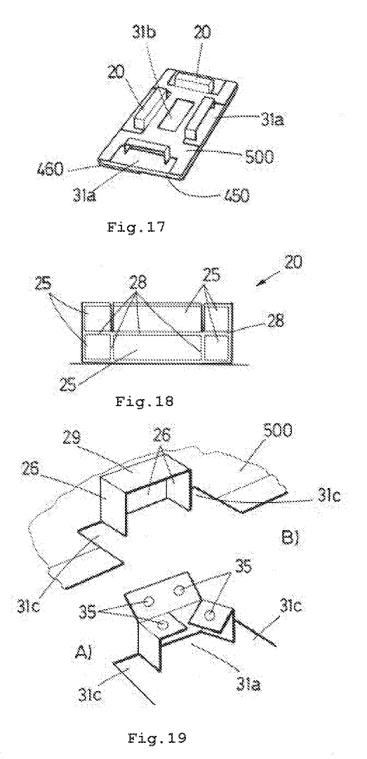

FIGS. 17 to 19 show another embodiment where the visual blocking device comprises a case 450 as first attaching means and a blocking sheet 500, with barrier elements 20, as second attaching means. This embodiment is similar to the previous one shown in FIGS. 14 to 16, but in this case the barrier element 20 is made up of six surfaces 25 than when folded out through folding lines 28 create a space with tree side vertical walls 26 and a horizontal wall 29 on top of the three previous ones 26. For maintaining this shape of the barrier elements 20 the polyurethane material of the same comprises magnets 35 within. When the barrier elements 20 are folded out, on each side of said barriers 20 an additional portion of the screen 31c can be used with other purposes. This additional portion 31c of the screen 31 can be seen by all the users. As in previous embodiments, once folded out the desired number of barriers 20, portions 31a of the screen 31 can be seen exclusively by the user placed in front of the barrier 20, preventing the users behind the barrier 20 from seeing the portion of the screen 31a in front of said barrier 20. The blocking sheet 500 comprises a window centered in the sheet 500 that allows another portion 31b of the screen 31 to be seen by all the users.

In these embodiments, the surface of the barrier element, mainly surfaces 26, and at least one of them, is inclined between 60° and 90° with respect to the screen 31 of the smart device 3.

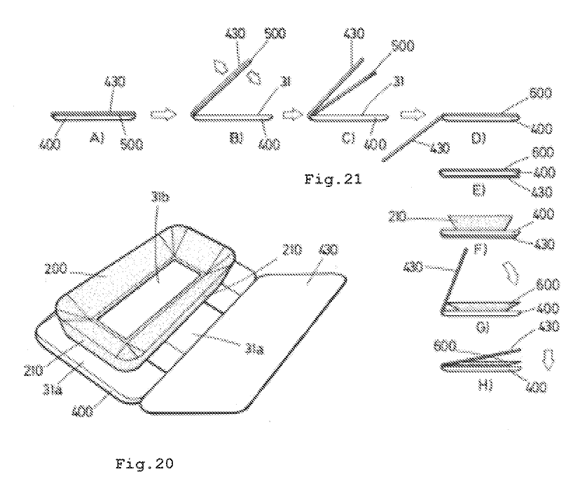

FIGS. 20 and 21 show an embodiment where the blocking sheet 600, as second attaching means, is hinged to a case 400 with a cover 430, as first attaching means, wherein said blocking sheet 600 constitutes the barrier element 200 with the shape, when folded out, of a stadium 200, although other 3D shapes could be designed. The shape of the stadium 200 is maintained with the action of magnets (not shown). The case 400 is made up of polycarbonate and the cover 430 is made of polyurethane, as well as the blocking sheet 600 that is placed between the cover 430 and the top surface of the smart device or screen 31 also in a hinged way. The blocking sheet 600 comprises magnets (not shown) in specified places to obtain the stadium 200 shape when said blocking sheet 600 is folded out from a first position, as a sheet 600, to its second position 200. The steps A to H of FIG. 21 show how the cover 430 is moved and the blocking sheet 600 with the shape of a stadium 200 is raised acting as a barrier 200, and how afterwards is pleated to the first position. The outside walls 210 of the stadium 200 have the same effect as the barriers of the previous embodiments and therefore act as said barriers, and determine each wall 210 a screen portion 31a that can only be seen by the user in front of the wall 210. In the middle of the stadium 200 there is another portion 31b of the screen 31 that can be seen by all the users.

In these embodiments, the barrier element 200, comprises a surface that is inclined between 60° and 90° with respect to the screen 31 of the smart device 3.

In an alternative embodiment, not shown in the figures, a 3D construction or shape folded out from a sheet, as the previously described stadium, and not attached to a cover could be used as blocking device. In this solution, the sheet containing the folded 3D shape as barrier element, could comprise different first attaching means such as U-shaped section elements on its sides (similar to the ones of FIG. 1) to adjust to the edgeways of the smart device. Other attaching means could also be used.

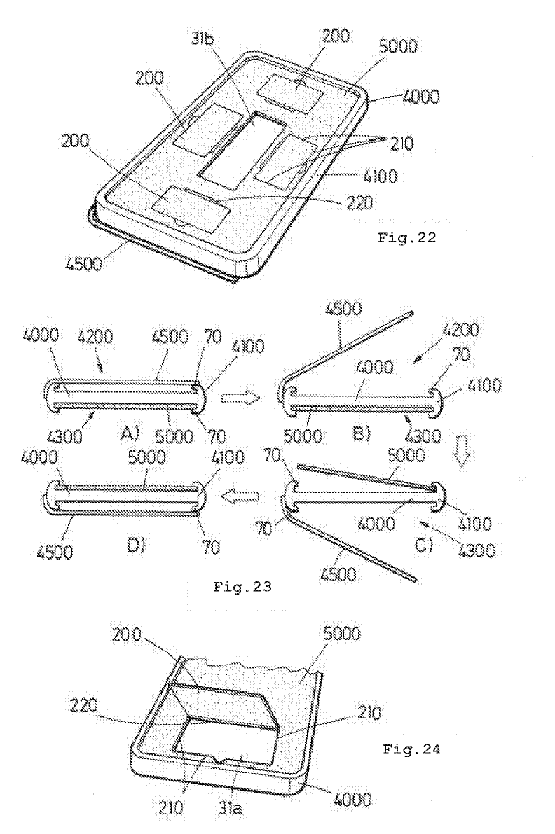

FIGS. 22 to 24 show a further embodiment where the first attaching means are a case 4000 comprising slots 70 in the lateral edges 4100 of the case 4000, specifically on the front 4200 and rear surface 4300 of the same. The smart device is placed inside the case between the front 4200 and rear surface 4300 with the screen 31 of the device facing the front surface 4200 of the case 4000. Said case 4000 comprises a hinged cover 4500 along one of its edges 4100. Further, a blocking sheet 5000, as second attaching means, is introduced within said slots 70, on the front surface 4200 or the rear surface 4300 depending if the barrier elements 200 are going to be used or not. In this embodiment, the case 4000 is preferably made of polycarbonate with certain parts of the slots 70 of silicone to allow certain flexibility to introduce the blocking sheet 5000, and the cover 4500 of polyurethane. The blocking sheet 5000 is made up of plastic with the barrier elements 200 having a rectangular shape with three cut sides 210 and one hinged side 220, to allow raising the barrier 200 to a second, folded out, position, from a first position where the barrier 200 is integrated within the clocking sheet 5000. Said barriers determine A portion of the screen 31a that can only be seen by the user in front of the barrier 200. Steps A to D, in FIG. 23, show how the blocking sheet 500 changes its position from the front side 4200 of the case 4000 to the rear side 4300 of the same. The blocking sheet 5000 comprises a window centered in the sheet 5000 that allows another portion 31b of the screen 31 to be seen by all the users.

In these embodiments, the surface of the barrier element, mainly surface 200 is inclined between 30° and 90° with respect to the screen 31 of the smart device 3.

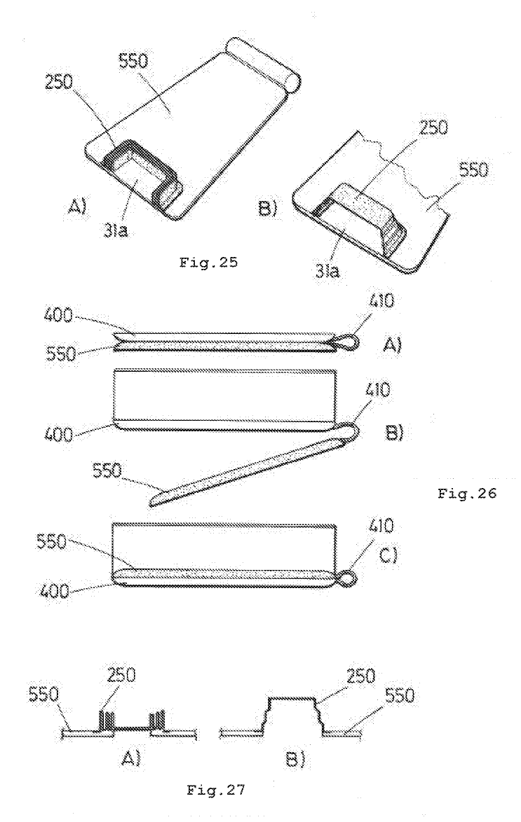

FIGS. 25 to 27 show another embodiment of a blocking device according to the present application. The first attaching means are a case 400, preferably of polycarbonate, for the smart device with a blocking sheet 550, preferably of polycarbonate too, as second attaching means, coupled to the case through a hinge or band 410, preferably of silicone, allowing the blocking sheet 550 to rotate over the case 400, and preferable fixing to said case through snap fit fittings. Said blocking sheet 550 comprises silicone barrier elements 250 embedded within, and through a bellow system the barrier elements 250 change from a first pleated or collapsed position, with the barrier element 250 and the blocking sheet 550 fixed to the case 400 (FIGS. 25A, 27A) to a second folded out position, with the barrier element 250 and the blocking sheet 550 fixed to the case 400 (FIGS. 25B, 27B). For folding out or collapsing the barrier elements it is necessary to exert a pressure on the barrier elements 250. Steps A to C, in FIG. 26, show how the blocking sheet 550 changes its position rotating from the rear side of the case 400 to the front side of the same. In FIG. 26A the blocking sheet 550 is fixed to the case preferably through snap fit means (not shown) and the barrier elements 250 are not in use, so the smart device can be used conventionally. In FIG. 26B the blocking sheet 550 is not fixed to the case 400 and starts rotating in respect to said case 400. In FIG. 26C the blocking sheet 550 is fixed, preferably through snap fit fittings, to the top of the screen and on the top of the case 400. Once on top of the screen, the barriers 250 can be folded out and therefore define the portion of the screen 31a that can only be seen by the user in front of the barrier element 250.

In these embodiments, one of the surfaces of the barrier element 250 is inclined between 30° and 90° with respect to the screen 31 of the smart device 3.

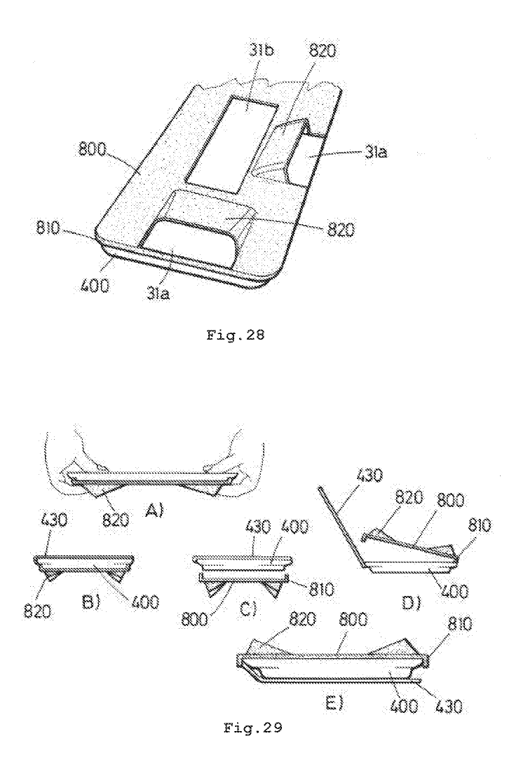

FIGS. 28 and 29 show another embodiment of the visual blocking device of the present invention, where the smart device is preferably inside a case 400 with a cover 430, and the first attaching means, that include the barrier elements 820, are a blocking sheet 800 that is fitted by pressure on the cover 400 or even directly on the smart device. The blocking sheet 800 comprises lateral walls 810 on its sides that allow the pressure fitting of the blocking sheet 800 on the sides of the cover 400 or of the smart device. FIG. 29 shows the steps A to E for disassembling and assembling the blocking sheet 800 with the barriers 820 on a case 400. In this embodiment, the barriers 820 have a determined and constant shape integrated within the blocking sheet 800, determining said barriers 820 the screen portions 31a with restricted visualization for all the users except the one who is in front of the barrier 820. In this embodiment, the barrier elements 820 do not have a first pleated position and a second folded out position.

In these embodiments, the surface of the barrier element, mainly surface 820 is inclined between 30° and 50° with respect to the screen 31 of the smart device 3.

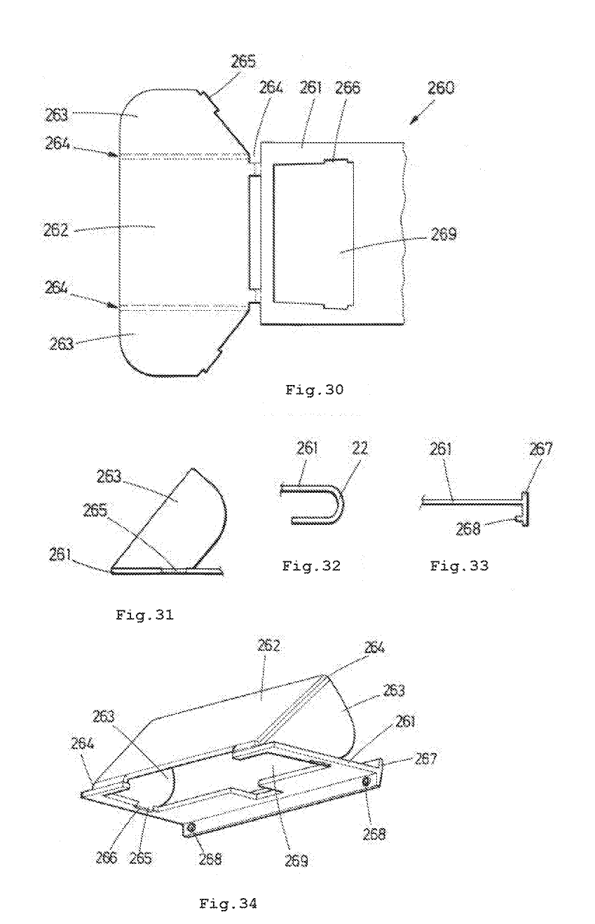

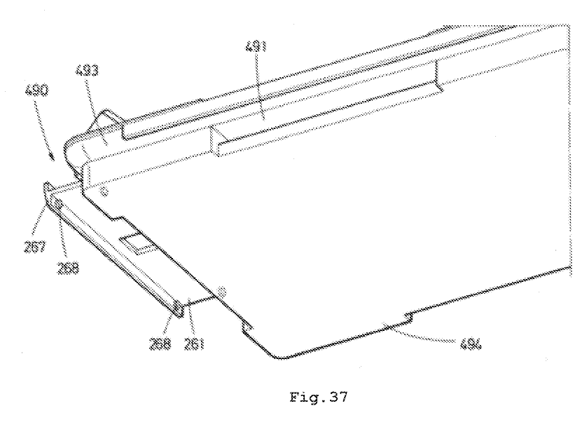

FIGS. 30 to 37 show the last embodiment of the present invention, where a barrier element 260 comprises a flat surface or tray 261 with three walls, a middle wall 262 and two side walls 263, being the middle wall 262 connected to the tray 261. Said tray 261 has a window 269. The three walls are preferably connected between them through hinges 264 and the middle wall 262 is connected too through a hinge 264 to the flat surface or tray 261. To prepare the barrier to be used, the side walls 263 fold in respect to the middle wall 262 and the middle wall 262 folds over the tray 261. The side walls 263 are coupled to the tray 261 through detachable attaching means, such as a tab 265 in the side walls 263 that is introduce in a housing or recess 266 in the tray 261. Said hinges 264 may be of different types, such as living hinges (as the ones shown in the figures), or flush hinges, or barrel hinges or piano hinges among others.

The blocking device of the invention can be attached to the smart device 3 through first attaching means 22 that have a U-shape section for adjusting to the edgeways of the smart device 3, preferably by pressure, as shown in FIG. 32, FIG. 1 or FIG. 3. In FIG. 32 said first attaching means 22 are placed on the opposite side of the tray where the tray 261 is coupled to the middle wall 262.

Further, in an alternative embodiment shown in FIGS. 33 to 36, the blocking device can comprise a barrier element 260 as the one shown in FIG. 30 and previously described, with second attaching means 268 that couple to first attaching means or case 490 where the smart device 3 is introduced. In this embodiment, the second attaching means 268 are placed on the opposite side of the tray where the tray 261 is coupled to the middle wall 262. Specifically, they are placed on a small wall 267 perpendicular to the tray 261. With this small wall the section of the tray 261 has a T-shape (FIG. 33) or an L-shape (not shown). The second attaching means 268 are preferably one or two small cylinders 268 that can be introduced in holes 492 on the case 490 or second attaching means. These second attaching means could also be magnets.

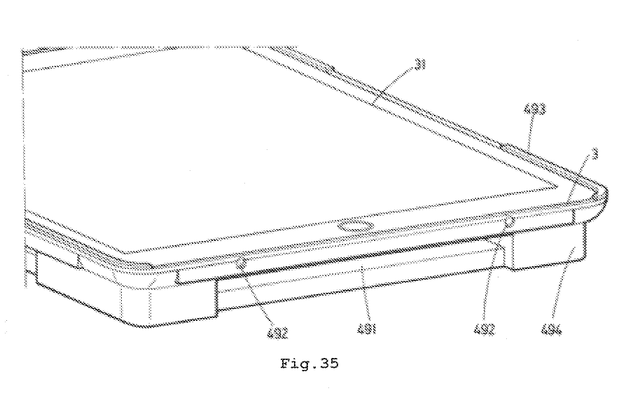

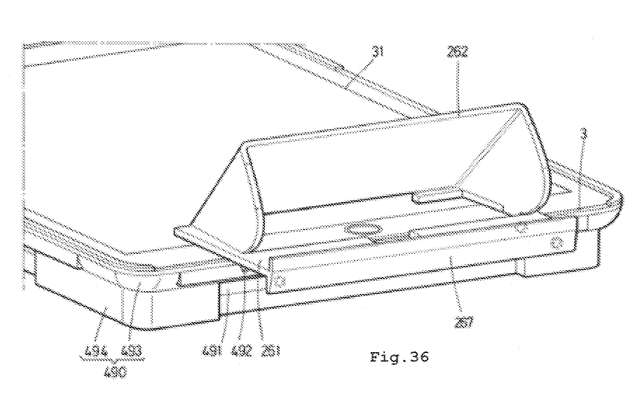

This solution for the second attaching means, shown in FIGS. 35 to 36, could also be used in the blocking devices described in FIG. 1 and FIG. 3. Anyway, other solutions could be used too, for example other mechanical solutions for the second attaching means, with the same purposes as the ones mentioned that allow the coupling by pressure of the barrier element to the first attaching means or case.

Said case 490 or second attaching means may have, in addition to the holes 492 for coupling to the barrier element 260, a housing for keeping the collapsed or pleated barrier element 260. For this purpose, the case 490 can be divided in two parts, an upper part 493 that houses the smart device 3 and a lower part 494 with lateral housings 491 for the barrier elements 260. The barrier elements 260 can be placed inside said housings 491 when they are not in use. When the user or player wants to use said barrier elements 260, he should extract them from the housings 491 in the lower part 494 of the case 490, and after folding the walls 262, 263 over the tray 261 and fixing the detachable coupling means 265, 266, introduce the second attaching means 268 in the holes 491 of the case 490 so that the tray 261 is paced on top of the screen 31 of the smart device 3.

Once coupled, the user will be able to see a portion 31a of the screen 31 of the smart device 3 through the window 269 of the barrier element 260 while the rest of users or player, placed behind said barrier element 260, will not be able to see said portion 31a of the screen 31. As in previous cases the case 490 can have up to 4 housings 491 for the barrier elements 260.

In this embodiment, the case 490 and the barrier elements 260 can be of PU, PP or PC as preferred material, preferably a rigid material as PP (polypropylene) or bi-materials, combining rigid and flexible materials.

In these embodiments, a surface of the barrier element, mainly surface 262 is inclined between 30° and 90° with respect to the screen 31 of the smart device 3.

The blocking sheet, or second attaching means, of all the previous embodiments comprise a central window that can be seen by all the users who are placed at the sides of the smart device, said window determining a screen portion 3b of the central part or area of the screen of said smart device. On the other hand, as previously explained the barriers determine smaller portions or areas 31a of the screen 31 that can only be viewed by one of the users, specifically the user placed in front of the barrier, blocking the visualization of said portion or area 31a of the screen 31 to the rest of the users.

On the outer side of the barriers, specifically on the side that cannot be seen by the user behind said barrier but can be seen by the user in front of him, it is possible to attach by different means a sheet of any material, preferably paper or cardboard, to show a thematic cover on the barrier. For example, when playing a game with a medieval thematic, said sheet made of foldable paper could cover the barriers with castles printed on the sheet. This sheet can be attached by magnets, adhesive, folded lines, or other means.
Lisbon, Jul. 31, 2015

1. A visual blocking device for the screen of a smart device, characterized in that it comprises:
at least one barrier element with a surface inclined with respect to the screen to prevent the visualization of part of the screen of the smart device, and
first attaching means to couple the barrier element to the smart device.

2. The visual blocking device, according to claim 1, characterized in that said at least one barrier element comprises:
said surface with its area smaller than the area of the screen of the smart device, and
conversion means that allow a portion of said surface of the barrier element to change from a first position parallel and in contact with the screen to a second position with a portion of the surface separated from the screen with the surface inclined with respect to said screen,
said portion of the surface of the barrier element blocking the visualization of a portion of the screen from a rear position and allowing the visualization of said portion of the screen from a front position when it is positioned separated from the screen.

3. The visual blocking device, according to claim 1, characterized in that said first attaching means are comprised within the barrier element and have a U-shape section for adjusting to the edgeways of the smart device.

4. The visual blocking device, according to claim 1, comprising second attaching means between the barrier element and the first attaching means to attach further said barrier element to said first attaching means.

5. The visual blocking device, according to claim 4, characterized in that said first attaching means are a case for the smart device.

6. The visual blocking device, according to claim 5, characterized in that said at least one barrier element is placed in a blocking sheet comprising a window, said window having an area smaller than the area of the screen and attached to said case through the second attaching means.

7. The visual blocking device, according to claim 6, characterized in that said window is centered with respect to the blocking sheet and centered with respect to the screen of the smart device.

8. The visual blocking device, according to claim 5, characterized in that said at least one barrier element is placed in at least one elastic band attached to said case and crossing the same from one side to its opposite being connected to said sides through the second attaching means.

9. The visual blocking device, according to claim 5, characterized in that said second attaching means are a foldable sheet connected to the case with a hinged connection between the blocking sheet and the foldable sheet, and between the foldable sheet and the case too.

10. The visual blocking device, according to claim 5, characterized in that said second attaching means are a hinged connection between the case and the blocking sheet.

11. The visual blocking device, according to claim 5, characterized in that said second attaching means is a projection on one of the edgeways of the case that allows the blocking sheet to rotate with respect to said projection and therefore with respect with the case.

12. The visual blocking device, according to claim 5, characterized in that said second attaching means are slots in the case for the insertion of the blocking sheet.

13. The visual blocking device, according to claim 6, characterized in that said at least one barrier element is incorporated in a rear sheet attached to the rear side of said case through the second attaching means.

14. The visual blocking device, according to claim 5, characterized in that said at least one barrier element is incorporated in the rear side of said case (4) through the second attaching means.

15. The visual blocking device, according to claim 13, characterized in that said second attaching means are a snap fit connection.

16. The visual blocking device, according to claim 13, characterized in that said at least one barrier element has a hinge connection to move from the rear side of the case to over the screen of the smart device.

17. The visual blocking device, according to claim 1, characterized in that the barrier elements are foldable.

18. The visual blocking device, according to claim 1, characterized in that the barrier element is inclined between 30° and 90° with respect to the screen of the smart device.

19. The visual blocking device, according to claim 2, characterized in that the conversion means of the barrier elements are slots or low profiles made in a silicone material to obtain a desired shape.

20. The visual blocking device, according to claim 2, characterized in that the conversion means of the barrier elements are magnets incorporated in material of the barrier element.

21. The visual blocking device, according to claim 5, characterized in that the case comprises an upper part to house the smart device and a lower part with housings to keep the barrier elements.

22. The visual blocking device, according to claim 1, characterized in that the barrier element comprises a flat surface or tray with three walls, a middle wall and two side walls, being the middle wall connected to the tray, being the three walls connected between them through hinges and the middle wall connected too through a hinge to the flat surface or tray.
